(19) United States
(12) Patent Application Publication
(10) Pub. No.: US 2011/0040006 A1
(43) Pub. Date: Feb. 17, 2011

(54) Compositions with Improved Dirt Pickup Resistance Comprising Layered Double Hydroxide Particles

(75) Inventors: Wolfgang Peter, Ludwigshafen (DE); Hans-Thomas Schacht, Rheinfelden (DE); Valentina Kharisovna Mitina, Wilmington, DE (US); Bernd Lamatsch, Riehen (CH); Karin Powell, Lorrach (DE)

Correspondence Address: BASF Corporation;Patent Department, 500 White Plains Road, P.O. Box 2005, Tarrytown, NY, 10591, US

(73) Assignee: BASF SE, Ludwigshafen (DE)

(21) Appl. No.: 12/844,092

(22) Filed: Jul. 27, 2010

Related U.S. Application Data
(60) Provisional application No. 61/234,339, filed on Aug. 17, 2009.

(51) Int. Cl. C08K 3/22

(52) U.S. Cl. 524/403; 524/436; 524/437; 524/401; 524/413; 524/435; 524/407; 524/406; 524/408

(57) ABSTRACT

The dirt pickup resistance of substrates, in particular coatings, is improved by the incorporation of small amount of certain layered double hydroxide particles. Methods for the preparation of effective, readily intercalated, layered double hydroxide particles and compositions comprising them, such as architectural coatings, in particular water based architectural coatings, are provided.

This application claims the benefit of U.S. provisional application No. 61/234,339, filed Aug. 17, 2009, herein incorporated entirely be reference.

The invention provides layered double hydroxide particles useful as additives to improve dirt pickup resistance of substrates, particularly coatings, methods for preparing the particles and dirt resistant coating formulations containing them.

The demands being placed on the surfaces of many everyday articles are increasing, for example, many well known commercial products and methods are available to make surfaces water repellant, water absorptive, oil repellent, stain resistant, dirt resistant, anti-microbial, anti adhesive, anti-static, anti-fog, anti-scratch are commercial products. Easy to clean surfaces with good dirt pickup resistance continue to attract commercial interest.

Surface characteristics such as dirt pickup resistance can be altered or enhanced in a number of ways, for example, by modifying the bulk material which makes up the substrate or by applying a coating to its surface. Co-pending U.S. patent application Ser. No. 12/321,542, incorporated herein in its entirety by reference, discloses a dirt resistant coating comprising of a network of metal oxides particles. Co-pending U.S. Pat. Appl. No. 61/210,370, incorporated herein in its entirety by reference, discloses organo-modified silica particles useful as additives to improve dirt pickup resistance of, for example, a coating.

The use of inorganic nanoparticles, such as clays and polymer-clay nanocomposites, as additives to enhance polymer performance is well established. Often, the clays used are organically modified, for example, intercalated clays wherein the clay lattice has been expanded to due to the insertion of individual polymer chains or other compounds, but which maintain a long range order in the lattice, and exfoliated clays wherein singular clay platelets are randomly suspended, resulting from extensive penetration of a material into the clay lattice and its subsequent delamination.

US Pub Pat Appl No. 20040220317 and U.S. Pat. No. 7,211,613, incorporated herein by reference, disclose polymer clay aqueous nanocomposite dispersions useful as coatings, sealants, caulks, adhesives, and as plastics additives and methods for their preparation, in particular methods using lightly hydrophobically modified clays. It is suggested that the coating compositions comprising the aqueous nanocomposite clay-polymer dispersions may exhibit, for example, dirt pick-up resistance, enhanced barrier properties and enhanced flame resistance. The coating compositions are useful as architectural coatings (particularly low VOC applications for semi-gloss and gloss); factory applied coatings (metal and wood, thermoplastic and thermosetting); maintenance coatings (e.g., over metal); automotive coatings; concrete roof tile coatings; elastomeric roof coatings; elastomeric wall coatings; external insulating finishing systems; and inks.

Clays are minerals typically comprised of hydrated aluminum silicates that are fine-grained and have a multi-layered structure comprised of combinations of layers of SiO₄ tetrahedra that are joined to layers of AlO(OH)₂ octahedra. Depending upon the clay mineral, the space between the layers may contain water and/or other constituents such as potassium, sodium, or calcium cations. Clay minerals vary based upon the combination of their constituent layers and cations. Naturally occurring elements within the gallery of the clay, such as water molecules or sodium or potassium cations, are attracted to the surface of the clay layers due to this net negative charge.

Another type of layered material is non-silicate layered double hydroxides or LDHs. In contrast to clays, LDHs contain cationically charged mineral layers of mixed metals with anionically charged interlayers, e.g., Cavini et al., Catalysis Today 11 (1991) 173-301, Elsivier Science Publishers, B. V., Amsterdam. WO 08/061,665 discloses LDHs comprising mineral layers of three part Ca, Zn and AL mixtures and carbonate anions.

Layered materials such as clays and LDHs can be splayed, that is, the layers can be at least partially separated by the introduction of a polymeric material. A material that is fully separated into its mineral layers is “exfoliated”; an “intercalated” material is one wherein another material, such as a polymer or other species, is inserted between the layers. A material can be fully or partially intercalated.

U.S. Pat. No. 7,273,899 discloses splayed materials, wherein the layers of e.g. clays are at least partially separated by the introduction of a polymeric material. While U.S. Pat. No. 7,273,899 is directed mainly at splayed clays, LDH materials such as hydrotalcites, i.e., a particular kind of LDH generally comprising Mg, Al, and CO₃ are mentioned.

LDHs have been mixed with clays and other silicates. U.S. Pat. No. 7,442,663 discloses a ceramic forming material formed by kneading a mixture of a ceramic forming clay and a LDH. JP 2002327135 discloses an antistatic and anti-soiling coating containing silica and hydrotalcites.

Certain LDHs have also been disclosed as additives in coating applications. CN 1715349 discloses the use of hydrotalcites in water-based polyurethane coating to improve mechanical and anti-UV properties. The impact of the introduction of certain LDH materials into polyurethane coatings has also been studied, especially in regards to stone chip resistance, for example, Troutier-Thuilliez et al., Progress in Organic Coatings 64 (2009) 182-192 and Hintze-Bruening et al., Progress in Organic Coatings 64 (2009) 193-204.

Regarding the above mentioned LDH materials, hydrotalcites typically comprise the bivalent carbonate anion and the papers of Troutier-Thuilliez and Hintze-Bruening specifically report on the behavior of carbonate containing LDH materials, and splayed materials thereof, of the formula MₓAl/CO₃²⁻ wherein M=Mg and/or Zn, and x=2, 3 or 4.

It has now been found that certain LDH materials, different from the above materials containing magnesium, aluminum and carbonate, when added to a coating comprising an organic binder, such as a water based coating comprising an organic binder, for example, an architectural coating, will greatly improve the dirt pick-up resistance of the dried coating. Parameters effecting the performance of the LDH include the composition of the cationically charged mineral layers, the materials that make up the anionically charged interlayers, the degree of splaying, i.e., intercalation or exfoliation, the nature of the splayant and the process by which the LDH is prepared. It is also found that an LDH prepared by co-precipitation using a combination of salts made up of Group II, Group III and/or transition metal salts and mono-valent anions, i.e., non-carbonate LDH materials, is readily intercalated with organic anions and is particularly useful in providing excellent dirt pick-up resistance even when used at low concentrations.

The LDH particles of the present invention can be prepared by a simple co-precipitation process and cheap starting material. Furthermore, as only low amounts of the LDH in the coating composition are needed to achieve the improved dirt pick-up resistance, there is only a minor, often negligible, impact on film properties such as elasticity or hardness, water vapor permeability and water absorption, or on the liquid paint properties such as rheology and viscosity. Intercalated materials, in particular, also demonstrate excellent dispersion and storage characteristic.

### DESCRIPTION OF THE INVENTION

Coatings comprising select layered double hydroxide particles exhibit excellent dirt pick-up resistance. Excellent results are achieved for example, when the coating is a water-borne coating comprising the LDH particles and a polymeric binder, for example, a water born architectural coating.

The invention thus provides a coating composition, such as an architectural coating composition, that provides a dirt resistant coating when applied to a substrate, the composition being in the form of an aqueous dispersion comprising:

a) from 0.1 to 20%, for example 0.25 to 10, 0.5 to 5 or 1 to 3%, by weight, based on the total weight of the coating solids, of layered double hydroxide particles which particles comprise at least two metals selected from Group II metals, Group III metals and transition metals, wherein at least one of the metals is a divalent cation,
b) a polymeric binder, and
c) water
with the proviso that layered double hydroxide particles comprising magnesium and aluminum as the Group II metals and Group III metals do not also comprise carbonate anions.

In one embodiment, layered double hydroxide particles which comprise aluminum, magnesium and/or zinc as the Group II metals and Group III metals along with carbonate anions are excluded from the composition.

In many embodiments of the invention, the layered double hydroxide particles are prepared from salts of monovalent anions and cations of each of the at least two metals selected from Group II metals, Group III metals and transition metals.

As opposed to clays, the mineral layers of the LDH particles of the invention are not silicate based materials, but comprise mixed hydroxides of Group II metals, Group III metals and transition metals, wherein at least one metal is a divalent cation. For example, the mineral layers comprise mixed hydroxides of a divalent cation and a trivalent cation, but mixed hydroxides containing three or more metal species may also be used. It is possible, for example, that the layered double hydroxide particles may comprise more than one divalent metal cation.

Good to excellent results are expected when the metals of the mineral layers are selected from Mg, Al, Ca, Ti, V, Cr, Mn, Fe, Co, Ni, Cu, Zn, Sr, Y, Zr, Mo, and Cd. IN one embodiment of the invention, the layered double hydroxide particles comprise at least one divalent metal cation selected from divalent Mg, Ca, Mn, Fe, Co, Ni, Zn and Sr and at least one trivalent metal cation selected from trivalent Al, Ti, Cr, Fe, and Mo, for example, the layered double hydroxide particles comprise at least two metals selected from Mg, Al, Ca, and Zn.

Typically, the layered double hydroxide particles comprise a divalent metal cation and a trivalent metal cation in a ratio of from 1.5:1 to 9:1.

While there are many types of known LDH materials, excellent properties are obtained using LDH particles which are prepared by co precipitation from salts of metal cations, e.g., di and tri valent cations and mono valent anions.

For example, salts containing mono-valent anions selected from halides, nitrate, hydroxide, amide, C₁₋₂₄ carboxylates, C₁₋₂₄ alkoxides, C₁₋₂₄ amides are useful in the preparation of the LDH particles of the invention. In one embodiment, the mono-valent anions are selected from halides, nitrate, hydroxide, C₁₋₄ carboxylates, C₁₋₄ alkoxides and in a particular embodiment, the mono-valent anions are selected from halides, nitrate, C₁₋₃ carboxylates and C₁₋₄ alkoxides.

The LDH particles of the invention can also partially or fully intercalated with certain organic anions. For example, in one embodiment of the invention, excellent results are achieved with LDH particles intercalated with organic anions comprising one or more carboxylate, sulfonate or phosphonate anions, often, the organic anions comprise one or more carboxylate anions. As referenced above, the intercalated particles can often provide dispersions with prolonged storage stability.

The materials used as intercalants must posses the correct mixture of properties, most important of which are acidic functionality, which also could be a hydroxyl group, for example a hydroxyl group on a sugar, and a certain solubility in water. Either small molecule organic anions or larger oligomeric or polymeric anions can be used. Typically the organic anion used in the intercalation will have a molecular weight of 20,000 or less, for example a molecular weight of between 100 and 20,000, in many embodiments, the molecular weight is between 100 and 3,000, for example, between 100 and 3,000.

In one particular embodiment of the invention the intercalant is an oligomer or polymer with a molecular weight of 20,000 or less, e.g. 1,000 to 15,000 and 50 to 100% of the monomer units of the polymer are derived from acrylic acid, methacrylic acid, fumaric acid and maleic acid, for example, 50 to 100% of the monomer units of the polymer are derived from acrylic acid.

Anions of naturally occurring materials, including bio-polymers, may also be used. For example, anions derived from vitamin C, lecithin, fatty acids, polysaccharide and agar can be used with good results.

The layered double hydroxide particles are conveniently prepared from salts of monovalent anions cations of each of the at least two metals selected from Group II metals, Group III and transition metals by co-precipitation from an alkaline aqueous mixture, typically at a pH of 12 or higher and some useful LDH particles are commercially available. The LDH particles may be used as prepared without intercalant, or the particles thus prepared may be splayed by treating with an intercalant via known procedures. In one particular embodiment, co-precipitation of the layered double hydroxide particles takes place in the presence of an intercalant, for example a carboxylate containing anion, to directly obtain intercalated particles.

Excellent results are achieved when the layered double hydroxide particles of the inventive coating are prepared by co-precipitation at a pH of 12 or higher from an aqueous mixture containing an alkylolamino carboxylate, for example, oligomeric or polymeric alkylolamino carboxylates, in particular those with a MW of about 200 to about 10,000, for example a MW of about 200 to about 1,000, including commercially available oligomeric and polymeric alkylolamino carboxylates.

The size of the LDH particle of the invention is determined to a large extent by the exact method of preparation and the amount of intercalation. Completely exfoliated materials are extremely thin flakes, e.g., as thin as about 1 nm, but are not the major component of the instant coatings. The intercalated materials, partially intercalated materials and non-intercalated LDH particles most commonly found in the invention are much larger and may be several microns thick or more. Some materials, such as amorphous particles obtained from some effective intercalated materials, or certain agglomerated materials may be much larger than that.

The is no particular limitation on which polymeric binder may be used with the LDH's of the invention, but as aqueous coatings are of particular interest, water soluble or water dispersible polymeric binders are of great value and excellent results are achieved using acrylic or methacryllic polymers or co-polymers, for example, styrene/acrylate copolymer etc, as polymeric binder.

The coating of the invention can comprise any coating system, or even a preformed film, and includes for example, auto coatings, marine coatings, industrial coatings, powder coatings, wood coatings, coil coatings, architectural coatings, paints, inks, laminates, receiving layers for printing applications, or other protective or decorative coatings including paper and fabric treatments and coatings or films used in glazing applications.

The coating composition according to the invention can be applied to any desired organic, inorganic or composite substrate such as synthetic and natural polymers, wood, metals, glass, mineral substrates such as concrete, plaster, bricks, stones and ceramics, etc by customary methods, for example by brushing, spraying, pouring, draw down, spin coating, dipping, applying with roller or curtain coater etc; see also Ullmann's Encyclopedia of Industrial Chemistry, 5th Edition, Vol. A18, pp. 491-500.

As mentioned above, there is no particular limitation on the polymeric binder or binders which may be incorporated into the coating of the invention which can in principle be any binder customary in industry, for example those described in Ullmann's Encyclopedia of Industrial Chemistry, 5th Edition, Vol. A18, pp. 368-426, VCH, Weinheim 1991. In general, it is a film-forming binder based on a thermoplastic or thermosetting resin. Examples thereof are alkyd, acrylic, acrylamide, polyester, styrenic, phenolic, melamine, epoxy and polyurethane resins.

For example, non-limiting examples of common coating binders also include silicon containing polymers, unsaturated polyesters, unsaturated polyamides, polyimides, crosslinkable acrylic resins derived from substituted acrylic esters, e.g. from epoxy acrylates, urethane acrylates, polyester acrylates, polymers of vinyl acetate, vinyl alcohol and vinyl amine. The coating binder polymers may be co-polymers, polymer blends or composites.

As noted above, aqueous coatings are of particular interest, water soluble or water dispersible polymeric binders are of great value. Aqueous coating materials, for example, include water-soluble or water-thinnable polymers or polymer dispersions. Highly polar organic film formers, such as polyvinyl alcohols, polyacrylamides, polyethylene glycols, cellulose derivatives, acrylates and polyesters with very high acid value are examples of water-soluble polymers. Water-thinnable film formers consist of relatively short-chain polymers with acid or basic groups capable of salt formation incorporated into the side chains. They are neutralized with suitable bases or acids, which evaporates during film formation leads to insoluble polymers. Examples thereof are short and medium oil carboxylic acid alkyd resins, water-thinnable melamine resins, emulsifiable epoxy resins or silicone-based emulsions. Several polymer types may be used as water-dilutable film formers. The coating material may also be a water-borne radiation-curable formulation of photopolymerisable compounds.

For example, the polymeric binder is an acrylic or methacryllic polymer or co-polymer.

The binder can be cold-curable, hot-curable or UV curable; the addition of a curing catalyst may be advantageous, and the binder may be cross-linked. The binder may be a surface coating resin which dries in the air or hardens at room temperature. The binder may also be a mixture of different coating resins. Many embodiments of the invention relate to surface coatings which are air dried at ambient temperature.

One embodiment of the invention provides a water based architectural coating or paint comprising LDHs of the invention and a polymeric binder which can be air dried at ambient temperature to leave a coating film with excellent dirt pick-up resistance.

The LDH materials of the invention are effective at low concentrations. For example, an aqueous coating composition comprises a polymeric binder, which in one embodiment comprises polymers and/or copolymers acrylic acid esters such as styrene/acrylate copolymers, at from about 5 to about 99%, for example from about 15 to about 95%, for example from about 25 to about 90%, by weight based on the total weight of coating solids and from 0.1 to 10% by weight based on the total weight of coating solids of the selected LDH. Excellent results are achieved, for example, using as little as 0.25, 1, 2, 3, 4, 5 or 6% weight percent, typically from 1-3 weight % of the selected LDH.

While particular embodiments of the invention relate to coating compositions, particularly aqueous coating compositions, it is noted that the particles of the invention, either intercalated or not, may be readily incorporated into a wide variety of naturally occurring or synthetic polymer compositions using common processing techniques. The naturally occurring or synthetic polymer, for example, may be a thermoplastic, thermoset, crosslinked or inherently crosslinked polymer, for example, a polyolefin, polyamide, polyurethane, polyacrylate, polyacrylamide, polyvinyl alcohol, polycarbonate, polystyrene, polyester, polyacetal, polysulfone, polyether, polyether ketone, cellulose ether, cellulose ester, halogenated vinyl polymers, a natural or synthetic rubber, alkyd resin, epoxy resin, unsaturated polyester, unsaturated polyamide, polyimide, fluorinated polymer, silicon containing polymer, carbamate polymer and copolymers and blends thereof.

The compositions of the invention of course may also comprise other customary additives such as fillers, reinforcing fibers wetting agents, dispersants, wetting agents, co-solvents, defoamers, leveling agents, thickeners (rheological additives), catalysts, driers, biocides, photoinitiators, processing aids, organic pigments, inorganic pigments including TiO₂ and effect pigments, dyes, light stabilizers, anti-oxidants, ageing inhibitors, buffers, anti-microbials, coalescent agents etc.

Conceptually, dirt pickup resistance seems simple: less foreign matter dirt is retained on the surface of an object. However, there is obviously more than one type of “dirt” and more than one type of chemical and/or physical interaction that leads to the adherence of “dirt”. For example, dirt with higher organic content tends to be more hydrophobic than dirt with higher inorganic content, which is often more hydrophilic. Thus, a proper dirt resistant surface would be resistant to many types of materials.

A complete, comparative assessment of dirt pick-up behavior of coating systems is generally difficult, not only are different coatings likely to vary in their resistance to different types of dirt, exposure under real world conditions will vary depending on the chosen climate/region (urban or rural type of pollution). Long periods of time are also required for a final rating which is not only inconvenient, but also introduces other variables. Therefore, for achieving quick results a laboratory method with model dirt substances is used as first indication for the behavior upon real life conditions. While some differences between the relative performance of different coatings in the lab tests versus real world use, the lab methods provide an indication as to which materials can be expected to demonstrate positive performance characteristics.

Additionally, in order to be commercially viable, the additives must also blend or disperse readily into a paint formulation, the dispersions must remain consistent throughout application and the paints containing the additives should be able to withstand storage reasonable periods of time without adversely affecting the overall quality of the paint formulation.

The following examples demonstrate that LDH additives of the present invention improve dirt resistance of paint surfaces, in particular aqueous paints based on organic binders, to such diverse materials as carbon black and iron oxide even when used in very small amounts. Both intercalated non-intercalated LDH particles are shown to have a positive impact on dirt pick-up resistance, although intercalated particles often provide advantages in storage stability and other physical properties.

### EXAMPLES

### 1. Preparation of Ca—Al-LDH

A solution containing 0.28 mol of Ca(NO₃)₂.4H₂O and 0.12 mol of Al(NO₃)₃.9H₂O in 320 ml of distilled water is added drop wise to a solution containing 0.6 mol of NaOH and 0.4 mol of NaNO₃. The pH of the final mixture is 12. The suspension is heated for 16 hours at 65° C. with vigorous stirring, after which the solid precipitate is collected by filtration and washed thoroughly with distilled water several times. The cake-like material is then dried for 16 hours at 100° C. under vacuum and characterized by elemental analyses and XRD spectroscopy.

### 2. Preparation of Ca—Al-LDH Intercalated with an Oligomeric Alkylolamino Carboxylate, (EFKA 5071, MW ˜400)

A solution containing 0.12 mol of Ca(NO₃)₂.4H₂O and 0.06 mol of Al(NO₃)₃.9H₂O in 150 ml of distilled water is added drop wise to a solution containing 347 g EFKA 5071 in 200 Ethanol/water (1:1). To keep the pH constant at 12.3 a solution of 0.44 mol NaOH in 220 ml ethanol/water (1:1) is added. The suspension is heated for 24 hours at 65° C. with vigorous stirring. The solid precipitate is collected by centrifugation and filtration and washed thoroughly with distilled water several times and characterized by elemental analyses and XRD spectroscopy. The metal content is assigned by calcination.

### 3. Dirt-Pick Up Resistance

The coating compositions comprising the LDH of Example 1, Example 2, and a coating without LDH are prepared by mixing the components (pos. 1-6) in the order shown in the table, dispersing the mixture for 30 minutes at 1500 rpm with high speed agitator, adding pos. 7-10 by stirring 45 min at 1900 rpm, adding the LDH as undried wet cake (pos. 11 or 12) and continuing stirring for 20 min at 1700 rpm and finally adding 13 and stir 30 min at 1800 rpm. The comparative coating composition without the LDH was prepared in an analogous manner, but without Position 11 or 12.

| Pos. | Components (in g) | Comp. | Ex.1 | Ex.2 |
|---|---|---|---|---|
| 1 | Water | 19.5 | 19.5 | 19.5 |
| 2 | Dispex ® GA40 (40% (w/w) aqueous dispersion of | 0.5 | 0.5 | 0.5 |
| | ammonium acrylic copolymer, Ciba) | | | |
| 3 | Tego ® foamex 1488 (emulsion of a polyether siloxane | 0.30 | 0.30 | 0.30 |
| | copolymer, Evonik) | | | |
| 4 | EFKA ® 2550 (modified polydimethyl siloxane, Ciba) | 0.20 | 0.20 | 0.20 |
| 5 | Kronos ® 2300 (titanium dioxide, pigment, Kronos) | 22.0 | 22.0 | 22.0 |
| 6 | Omyacarb ® 5GU (calcium carbonate, filler, Omya) | 12.0 | 12.0 | 12.0 |
| 7 | Water | 5.5 | 5.5 | 5.5 |
| 8 | Dowanol DPM ® (dipropylene glycol methylether, Dow) | 2.0 | 2.0 | 2.0 |
| 9 | Octylisothiazolinone (biocide, Beckmann) | 0.5 | 0.5 | 0.5 |
| 10 | Alberdingk ® AS 6002 (50% (w/w) aqueous dispersion of | 38.0 | 38.0 | 38.0 |
| | acrylic acid ester/styrene copolymer, Alberdingk Boley) | | | |
| 11 | Ex.1 (15% w/w solid in water) | 0.0 | 7.1 | 0.0 |
| 12 | Ex.2 (25% w/w solid in water) | 0.0 | 0.0 | 4.3 |
| 13 | Natrosol ® 250 HR (hydroxyethylcellulose surface- | 0.5 | 0.5 | 0.5 |
| | treated with glyoxal, thickener, Hercules) | | | |
| | Total components | 101.0 | 108.1 | 105.3 |
| | Solid content | 53.0 | 54.1 | 54.1 |
| | LDH on solid | — | 2.0 | 2.0 |

The water-based, white-pigmented coating compositions are suitable for use as exterior architectural coating formulations.

The coating compositions are applied on a white, coil coated aluminum panel with a 200 μm slit coater and dried for 3 days at room temperature to form coating layers. The amount of the solid LDH-particles is 2.0% based on the amount of the sum of the major solid components of the coating compositions.

Dirt pick-up tests are performed with black iron-oxide (33% (w/w) FeOx) slurry. Before application of the slurry a color measurement of each panel is conducted. The slurry is then applied on the coated panels and allowed to dry for 3 hours at room temperature. The panels are then cleaned with tap water and a sponge and allowed to dry. Color measurements of each panel, now slightly to moderately gray, are conducted. Color measurements are taken with spectrophotometer and calculation of L*, a*, b*, C*, h and DL* with CGREC software according DIN 6174. Results are displayed in the table as the difference between the panels before application of the slurry and after application and washing (DL* values are given without algebraic sign and are average values of three single samples).

| | | Difference in DL* |
|---|---|---|
| Composition | DL* (FeOx) | Ex.-Comp. 1 |
| Comp. 1 | 19.0 | — |
| 2% (w/w) Ex. | 18.0 | 11.0 |
| 2% (w/w) Ex. | 29.8 | 9.2 |

The coating layers comprising the LDH (Ex. 1 or Ex. 2) have DL* values of 8 or 9.8 compared with a DL* value of 19.0 for the coating without the LDH which indicates a significant positive effect of the inventive LDH particles on dirt pick-up resistance of the coated panels. The final column of the table shows the difference in color change between the test sample and the comparative sample.

### Example 4-30

To assess the impact of the species used as intercalant, Ca—Al-LDH prepared from Ca(NO₃)₂.4H₂O and Al(NO₃)₃ intercalated with various organic species are prepared and tested for dirt pickup resistance using slurries of graphite and black iron oxide.

Following a procedure analogous to that of Example 2, the following materials are prepared using the listed intercalant in place of EFKA 5071. There is no intercalant in Example 4. The calcium/aluminum and carbon/aluminum rations as well as the degree of intercalation is given in the table. Full intercalation means that the intercalant has completely penetrated the LDH layers but does not mean exfoliation. Coated means that the intercalant has surrounded the LDH particle but has not significantly penetrated the layers.

| Ex | Intercalant | Mol-Weight | Ca/Al ratio | C/Al ratio | Intercalation |
|---|---|---|---|---|---|
| 4. | Synthesis without organic moiety | | 2.9 | 0.2 | none |
| 5. | maleinated trifunctional fatty acid | <500 | 3.3 | 5.1 | full |
| 6. | dimeric and trimeric fatty acid | <500 | 3.2 | 10.7 | full |
| 7. | acid version of EFKA 5071 | <500 | 3.5 | 8.0 | full |
| 8. | mono unsaturated fatty acid | <300 | organic unit | | none |
| | | | not water-soluble | | |
| 9. | Poly-Acrylic Acid NH4 salt | 5,000 | 3 | 3.6 | full |
| 10. | Poly-Acrylic Acid Na salt | 5,000 | 3 | 2.3 | full |
| 11. | Acrylic acid copolymer | 10,000 | 3 | 3.8 | full |
| 12. | Acrylic acid copolymer | 10,000 | 3 | 3.0 | full |
| 13. | Acrylic block copolymer | 5,000 | 3 | 3.0 | full |
| 14. | Poly-Acrylic free Acid | 5,000 | 3 | 2.9 | full |
| 15. | Poly-Acrylic Acid amine salt | 5,000 | 3 | 6.3 | partial |
| 16. | Acrylic block copolymer | 12000 | 3 | 6.3 | coated |
| 17. | High MW acrylic polymer | 20,000 | 3 | 2.8 | coated |
| 18. | fluoro polymer with | ~1000 | 3.1 | 4.6 | partial |
| | carboxylic acid groups | | | | |
| 19. | fluoro polymer with | <2000 | 3 | 4.8 | partial |
| | carboxylic acid groups | | | | |
| 20. | Neutralized fluorocarbon | 3,000 | 3 | 5.4 | full |
| | modified polyacrylate | | | | |
| 21. | Polyfox: F-Polymer with OH | 500 | 2.9 | 8.9 | coated |
| 22. | α-ω Siloxane | 4000 | 2.8 | 5.8 | coated |
| 23. | phosphoric acid end group | <500 | 2.2 | 0.7 | partial |
| 24. | Fatty acid modified polymer + | 500-3000 | 2.8 | 7.2 | full |
| | sulfonic acid | | | | |
| 25. | Neutralized fluorocarbon | 3,000 | 3 | 5.4 | full |
| | modified polyacrylate | | | | |
| 26. | OH functional unsaturated | <500 | 3 | 9.2 | full |
| | modified carboxylic acid | | | | |
| 27. | Ascorbic acid | 179 | 3.2 | 2.8 | full |
| 28. | Unbranched polysaccharide | ~20′000 | 3 | 1.8 | full |
| 29. | Lecithin | ~800 | 3.2 | 6.7 | full |
| 30. | Lutensit A: sulfonic acid | <500 | 3.2 | 7.2 | full |

The materials from Examples 4-30 are incorporated into the coating of Example 3. After the coating films are formed on the panels, each is tested for dirt pickup resistance using the procedure of Example 3 with slurries of iron oxide and graphite. In the table the difference between the DL* value of the tested example and the DL* value of the comparative formulation (without LDH) is listed (the higher the value the better the effect on dirt pick-up resistance). As stated before the values indicate that the tested materials have a considerable effect on the dirt pick-up.

| | | | Graphite DL* | FeOx DL* |
|---|---|---|---|---|
| | | | Difference of | Difference of |
| Ex | | MW | Ex-comp.1 | Ex-comp.1 |
| 4. | Synthesis without organic | | 2.3 | 9.5 |
| | moiety | | | |
| 5. | maleinated trifunctional | <500 | 9.0 | 9.5 |
| | fatty acid | | | |
| 6. | dimeric and trimeric fatty | <500 | 4.2 | 4.8 |
| | acid | | | |
| 7. | acid version of EFKA 5071 | <500 | 6.3 | 6.6 |
| 8. | mono unsaturated fatty acid | <300 | | |
| 9. | Poly-Acrylic Acid NH4 salt | 5,000 | 11.5 | 4.1 |
| 10. | Poly-Acrylic Acid Na salt | 5,000 | 11.9 | 5.4 |
| 11. | Acrylic acid copolymer | 10,000 | 11.6 | 9.6 |
| 12. | Acrylic acid copolymer | 10,000 | 8.6 | 9.0 |
| 13. | Acrylic block copolymer | 5,000 | 8.6 | 7.4 |
| 14. | Poly-Acrylic free Acid | 5,000 | 1.8 | 4.1 |
| 15. | Poly-Acrylic Acid amine | 5,000 | 7.1 | 6.2 |
| | salt | | | |
| 16. | Acrylic block copolymer | 12000 | 10.1 | 1.8 |
| 17. | High MW acrylic polymer | 20,000 | 7.0 | 5.5 |
| 18. | fluoro containing polymer | | | |
| | with carboxylic acid groups | ~1000 | 6.9 | 4.4 |
| 19. | fluoro containing polymer | | | |
| | with carboxylic acid groups | <2000 | 2.4 | 7.5 |
| 20. | Neutralized fluorocarbon | | | |
| | modified polyacrylate | 3,000 | 16.0 | 2.3 |
| 21. | Polyfox: F-Polymer with OH | 500 | 0.9 | 0.4 |
| 22. | α-ω Siloxane | 4000 | 0.9 | 1.0 |
| 23. | phosphoric acid end group | <500 | 3.9 | 7.4 |
| 24. | Fatty acid modified | | | |
| | polymer + sulfonic acid | 500-3000 | 6.4 | 3.1 |
| 25. | Neutralized fluorocarbon | | | |
| | modified polyacrylate | 3,000 | 16.0 | 2.3 |
| 26. | Hydroxy functional | | | |
| | unsaturated modified | | | |
| | carboxylic acid | <500 | 4.8 | 5.1 |
| 27. | ascorbic acid | 179 | 7.2 | 5.6 |
| 28. | unbranched polysaccharide | ~20′000 | 3.3 | 9.0 |
| 29. | Lecithin | ~800 | 2.2 | 6.7 |
| 30. | Lutensit A: sulfonic acid | <500 | 3.2 | 5.3 |

### Example 31

A coating with different binder composition comprising the LDH of Example 2, and a coating without LDH are prepared by mixing the components (pos. 1-7) in the order shown in the table, dispersing the mixture for 30 minutes at 1500 rpm with high speed agitator, adding pos. 8-11 by stirring 45 min at 1900 rpm, adding the LDH as un-dried wet cake (pos. 12) and continuing stirring for 20 min at 1700 rpm and finally adding 13 and stir 30 min at 1800 rpm. The comparative coating composition without the LDH was prepared in an analogous manner, but without Position 12.

| Pos. | Components (in g) | Comp.2 | Ex.2 |
|---|---|---|---|
| 1 | Water | 29.20 | 24.47 |
| 2 | Dispex ® GA40 (40% (w/w) aqueous dispersion | 0.5 | 0.5 |
| | of ammonium acrylic copolymer, Ciba) | | |
| 3 | Tego ® foamex 1488 (emulsion of a | 0.30 | 0.30 |
| | polyether siloxane copolymer, Evonik) | | |
| 4 | EFKA ® 2550 (modified polydimethyl | 0.20 | 0.20 |
| | siloxane, Ciba) | | |
| 5 | Kronos ® 2300 (titanium dioxide, pigment, | 22.0 | 22.0 |
| | Kronos) | | |
| 6 | Omyacarb 5GU (calcium carbonate, filler, Omya) | 12.0 | 12.0 |
| 7 | SE-Micro (talcum, Naintsch) | 3.0 | 3.0 |
| 8 | Water | 5.5 | 5.5 |
| 9 | Dowanol DPM ® (dipropylene glycol | 2.0 | 2.0 |
| | methylether, Dow) | | |
| 10 | Octylisothiazolinone (biocide, Beckmann) | 0.5 | 0.5 |
| 11 | Alberdingk ® SC 4400 (50% (w/w) aqueous | 30.0 | 30.0 |
| | dispersion of acrylic acid ester/styrene | | |
| | copolymer, Alberdingk Boley) | | |
| 12 | Ex.2 (22% w/w solid in water) | 0.0 | 4.73 |
| 13 | Natrosol ® 250 HR (hydroxyethylcellulose | 0.5 | 0.5 |
| | surface-treated with glyoxal, thickener, Hercules) | | |
| | Total components | 100.0 | 100.0 |
| | Solid content | 52.0 | 53.0 |
| | LDH on solid | — | 2.0 |

The water-based, white-pigmented coating compositions are suitable for use as exterior architectural coating formulations.

The coating compositions are applied on a white, coil coated aluminum panel with a 200 μm slit coater and dried for 3 days at room temperature to form coating layers. The amount of the solid LDH-particles is 2.0% based on the amount of the sum of the major solid components of the coating compositions.

Dirt pick-up test is performed with graphite slurry. Before application of the slurry a color measurement of each panel is conducted. The slurry is then applied on the coated panels and allowed to dry for 3 hours at room temperature. The panels are then cleaned with tap water and a sponge and allowed to dry. Color measurements of each panel, now slightly to moderately gray, are conducted. Color measurements are taken with spectrophotometer and calculation of L*, a*, b*, C*, h and DL* with CGREC software according DIN 6174. Results are displayed in the table as the difference between the panels before application of the slurry and after application and washing (DL* values are given without algebraic sign and are average values of three single samples).

| | | Difference in DL* |
|---|---|---|
| Composition | DL* (graphite) | Ex.-Comp. 1 |
| Comp.31 | 15.3 | — |
| 2% (w/w) Ex. 31 | 11.7 | 3.6 |

1. A coating composition that provides a dirt resistant coating when applied to a substrate, the composition being in the form of an aqueous dispersion comprising:
a) from 0.1 to 20%, by weight, based on the total weight of the architectural coating solids, of layered double hydroxide particles which particles comprise at least two metals selected from Group II metals, Group III metals and transition metals, wherein at least one of the metals is a divalent cation,
b) a polymeric binder, and
c) water,
with the proviso that layered double hydroxide particles comprising magnesium and aluminum as the Group II metals and Group III metals do not also comprise carbonate anions.

2. A coating composition according to claim 1, wherein the layered double hydroxide particles are prepared from salts of monovalent anions and cations of each of the at least two metals selected from Group II metals, Group III and transition metals.

3. A coating composition according to claim 1, wherein the coating composition is an architectural coating composition.

4. A coating composition according to claim 1 wherein the layered double hydroxide particles comprise a divalent metal cation and a trivalent metal cation in a ratio of from 1.5:1 to 9:1.

5. A coating composition according to claim 1 wherein the layered double hydroxide particles comprise more than one divalent metal cation.

6. A coating composition according to claim 1 wherein the metals of the layered double hydroxide particles are selected from Mg, Al, Ca, Ti, V, Cr, Mn, Fe, Co, Ni, Cu, Zn, Sr, Y, Zr, Mo, and Cd.

7. A coating composition according to claim 1 wherein the layered double hydroxide particles comprise at least one divalent metal cation selected from divalent Mg, Ca, Mn, Fe, Co, Ni, Zn and Sr and at least one trivalent metal cation selected from trivalent Al, Ti, Cr, Fe, and Mo.

8. A coating composition according to claim 1 wherein the layered double hydroxide particles comprise at least two metals selected from Mg, Al, Ca, and Zn.

9. A coating composition according to claim 1 wherein the mono-valent anions are selected from halides, nitrate, hydroxide, amide, C₁₋₂₄ carboxylates, C₁₋₂₄ alkoxides, C₁₋₂₄ amides.

10. A coating composition according to claim 1 wherein the mono-valent anions are selected from halides, nitrate, hydroxide, C₁₋₄ carboxylates, C₁₋₄ alkoxides.

11. A coating composition according to claim 1 wherein the mono-valent anions are selected from halides, nitrate, C₁₋₃ carboxylates.

12. A coating composition according to claim 1 wherein the layered double hydroxide particles are partially or fully intercalated with at least one organic anion wherein the organic anion comprises one or more carboxylate, phosphoric or sulfonic anions.

13. A coating composition according to claim 12 wherein the organic anion is an oligomer or polymer with a molecular weight of between 200 and 20,000 comprising carboxylate containing monomer units.

14. A coating composition according to claim 13 wherein 50 to 100% of the monomer units of the polymer are derived from acrylic acid, methacrylic acid, fumaric acid and maleic acid.

15. A coating composition according to claim 12 wherein the organic anion is selected from ascorbic acid, lecithin, fatty acids and polysaccharides.

16. A coating composition according to claim 12 wherein the layered double hydroxide particles are prepared from salts of monovalent anions cations of each of the at least two metals selected from Group II metals, Group III and transition metals by co-precipitation from an alkaline aqueous mixture in the presence of a carboxylate containing anion.

17. A coating composition according to claim 16 wherein the layered double hydroxide particles are prepared by co-precipitation from an aqueous mixture at a pH of 12 or higher.

18. A coating composition according to claim 17 wherein the layered double hydroxide particles are prepared by co-precipitation from an aqueous mixture containing an alkylolamino carboxylate at a pH of 12 or higher.

19. A coating composition according to claim 1 wherein the polymeric binder is an acrylic polymer or co-polymer.

20. A coating composition according to claim 1 which also comprises additional components selected from pigments, fillers, dispersants, thickeners, defoamers, leveling agents, wetting agents, co-solvents, anti-oxidants, light stabilizers, buffers, anti-microbials, and coalescent agents. fillers, reinforcing fibers wetting agents, dispersants, wetting agents, co-solvents, defoamers, leveling agents, thickeners, catalysts, driers, biocides, photoinitiators, processing aids, organic pigments, inorganic pigments, dyes, light stabilizers, anti-oxidants, ageing inhibitors, buffers, anti-microbials and coalescent agents.
